(19) United States
(12) Patent Application Publication
(10) Pub. No.: US 2007/0043727 A1
(43) Pub. Date: Feb. 22, 2007

(54) Electronic data transfer of regulatory-related documents

(75) Inventors: Walter R. Beck, Redmond, VA (US); Steven D. Cressey, Renton, WA (US); William P. Mahr, Puyallup, WA (US); Michael D. Wall, Seattle, WA (US); Kenneth E. Wenner, Covington, WA (US)

Correspondence Address: BAKER & HOSTETLER, LLP;FOR BOEING COMPANY, WASHINGTON SQUARE, SUITE 1100, 1050 CONNECTICUT AVENUE, N.W., WASHINGTON, DC, 20036, US

(73) Assignee: The Boeing Company

(21) Appl. No.: 11/207,708

(22) Filed: Aug. 22, 2005

(51) Int. Cl. G06F 17/30

(52) U.S. Cl. 707/9

(57) ABSTRACT

Techniques for providing regulatory-related documents to a government entity includes a computer-based server are disclosed. A computer-based server networked to the Internet provides secure document handling and distribution over the Internet without data encryption.

### FIELD OF THE INVENTION

This invention relates to methods and systems for providing regulatory documents to government agencies.

### BACKGROUND OF THE INVENTION

Government-imposed regulation is not a new concept by any means. However, the historically recent explosions of technology and industrialization have spawned the need for seemingly endless reams of new and complex regulations.

Whether a particular set of regulations are designed to protect worker safety, ensure the quality of the food supply, contain pollution and so on, the sheer quantity and complexity of regulations has made filing reports on every form regulatory compliance onerous as the United States government presently requires that all official regulatory compliance documents to be filed by hardcopy via post, courier or hand-delivery. As such, new methods and systems directed to delivering regulatory documents to government officials is desirable.

### SUMMARY OF THE INVENTION

Despite the present restrictions on the delivery of regulatory documents, regulatory officials can still benefit from unofficial document filings that might be delivered by electronic form. For example, electronic documents might be delivered to officials in a more timely fashion, can be easier to reproduce, easier to distribute and the information within can be easier to incorporate into other documents.

The advantages of using the disclosed methods and systems are notable not just for their apparent utility, but also because they transcend any other known approach which uses computers to solve regulatory auditing issues. Indeed, history shows that certain forms of government regulations have been around for millennia, communications networks have been around for over a century, the Internet with its predecessors have been around for over thirty years, computer-based auditing tools have been around for decades, and so on, yet no one has attempted a noteworthy approach to regulatory auditing. That is, despite the fact that both the problems and the basic technology were publicly known for decades, no one had previously conceived and assembled the various disclosed methods and systems in such a way to create a comparable auditing tool.

In a first of embodiments, an apparatus for providing regulatory-related documents to a government entity includes a computer-based server, the computer based server including a network interface coupled to the Internet, a first memory coupled to the computer-based server, the first memory containing number of regulatory-related documents, each regulatory-related document being a deliverable product directed to a regulatory agency of a government, a second memory coupled to the computer-based server, the second memory containing a client database, the client database including information related to one or more clients, and a security device coupled to the first and second memory, the security device being configured to restrict access of at least a first regulatory-related document in the first memory to a first client based on information in the second memory.

In a second embodiment, a memory assessable to an apparatus for providing regulatory-related documents to a government entity, the memory includes a plurality of records with each record having a client identification field directed to a first official of a regulatory agency of the United States government, a client contact information field having an electronic mail address of the first official, and one or more fields indicating at least one document reserved for the first official, each document being a regulatory-related document being a deliverable product directed to a regulatory agency of the United States government.

In a third embodiment, a method for providing regulatory-related documents to a government entity includes receiving and storing a number of first regulatory-related documents, each regulatory-related document being a deliverable product directed to a first regulatory agency of the United States government, wherein access to the regulatory-related documents is restricted based on first restriction information, sending a first message to a first official of the first regulatory agency over a non-secure network, receiving identification information from the first official, the identification information being keyed to provide access to the first regulatory-related documents, and providing access of the first regulatory-related documents to the first official based on the received identification information and the first restriction information.

There has thus been outlined, rather broadly, certain embodiments of the invention in order that the detailed description thereof herein may be better understood, and in order that the present contribution to the art may be better appreciated. There are, of course, additional embodiments of the invention that will be described or referred to below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram depicting a networked-system capable of delivering regulatory documents in a secure fashion.

FIG. 2 is a block diagram depicting an exemplary electronic document providing device.

FIG. 3 depicts and exemplary client database.

FIG. 4 is a flowchart outlining a first exemplary operation.

FIG. 5 is a flowchart outlining a second exemplary operation.

### DETAILED DESCRIPTION

As mentioned above, official documents to U.S. regulatory agencies must be delivered in hardcopy form. However, despite this requirement, regulatory officials can still benefit from unofficial (e.g., electronic) document forms and nonstandard delivery (e.g., by email) of official documents. For example, electronic documents might be delivered to officials in a more timely fashion, can be easier to reproduce, easier to distribute and the information within can be easier to incorporate into other documents.

Another advantage of the disclosed methods and systems is that while the such methods and systems can be combined with various forms of encryption, an advantage provided by the disclosed methods and systems is that a secure document delivery system can be maintained without the need of encryption and the special tools and software necessary to support it.

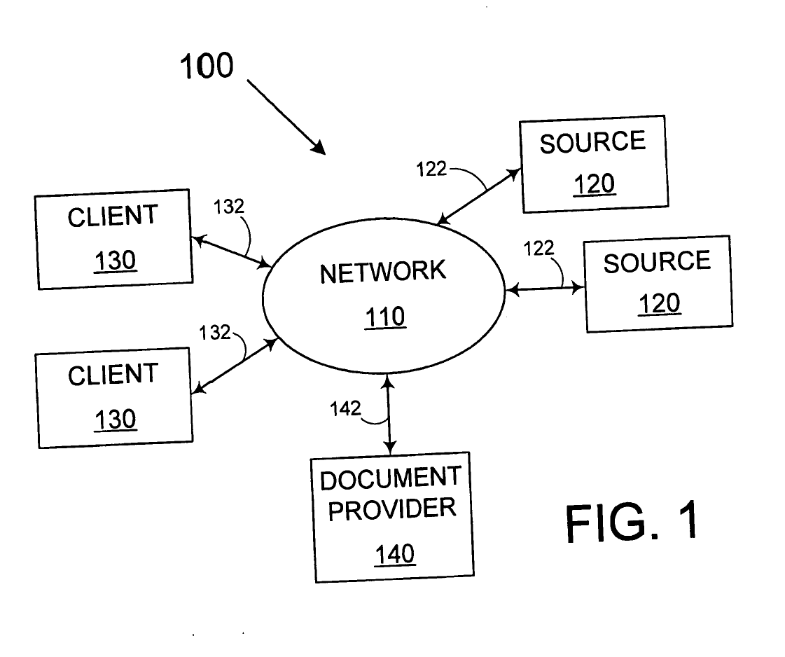

FIG. 1 depicts an exemplary networked-system 100 configured to enable the distribution of regulatory documents. As shown in FIG. 1, the networked-system 100 includes a document-provider site 140 coupled to a network 110 via link 142, a number of client-sites 130 coupled to the network 100 via respective links 132 and a number of document sources 120 coupled to the network 100 via respective links 122.

Before standard operation, the various intended benefactors of the system 100, e.g., regulatory officials at the client sites 130, can create an account with the document provider 140. Generally, such an account can require some form of unique I.D. code with an optional password and/or optional internet address verification. However, the particular form of verification can vary from embodiment to embodiment without departing from the spirit and scope of the present disclosure.

Once in operation, a document source 120, e.g., a government contractor or another entity responsible for reporting of a government regulated activity, can first draft any number of regulatory-related documents related to any regulated activity. For instance, some particularly good examples of such regulated activity can be found in the various titles of the United States Code of Federal Regulations, such as workplace safety, energy, transportation (e.g., the manufacturing, maintenance, product compliance, testing and operation of a military or civilian aircraft), accounting, banking, internal revenue, mineral resources, emergency management and assistance, commercial practices, commerce and foreign trade, elections, commodity and securities exchanges, employees benefits, homeland security, national defense and agriculture. Appropriate regulations also can be found in the various rules promulgated by various government bureaucracies, the various standards promulgated by commercial standards-making bodies, e.g., the International Telecommunications Union, or in any other situation where regulatory compliance is necessary or desirable.

While the present disclosure shows a particular use for U.S. government agencies and their officials, e.g., program directors and other government employees, the disclosed methods and systems can also apply to any number of foreign governments and their agencies, e.g., the European space Agency (ESA), Japan's JCAB, China's CAAC and so on. Still further, the disclosed methods and systems can also apply to any number of public and private companies working for or with a government. For example, a duly-entitled representative, e.g., a corporate manager, of a private company co-operating with an agency might be entitle to receive any number of regulatory documents in order to supervise progress of a government program.

Once the appropriate documents are prepared, the documents can be sent from any of the sources 120 to the document provider 140 via the network 110 or by any other electronic means, such as another network. Next, the providers of the documents can supply information to the document provider 140 as to the intended recipient of the regulatory documents.

Once the document provider 140 has the documents and the identity of the intended recipient, the document provider 140 can send an email or any other electronic transmission to the intended recipient, such as an automated voice message, a page, a facsimile, an instant message etc., informing the intended recipient that the document provider 140 has a number of regulatory documents of interest from a particular source 120.

In response, the intended recipient can access the document provider 140 via a client site 130, and download the documents. Afterward, a message to the appropriate source 120 (or other party) can be provided by the document provider 140 indicating that the documents were accessed/downloaded by the appropriate recipient.

The exemplary network 110 is a portion of the Internet. However, in other embodiments the network 110 can be any viable combination of devices and systems capable of linking computer-based systems including a wide area network, a local area network, a connection over an intranet or extranet, a connection over any number of distributed processing networks or systems, a virtual private network, the Internet, a private network, a public network, a value-added network, an intranet, an extranet, an Ethernet-based system, a Token Ring, a Fiber Distributed Datalink Interface (FDDI), an Asynchronous Transfer Mode (ATM) based system, a telephony-based system including T1 and E1 devices, a wired system, an optical system, a wireless system and so on.

The various links 122, 132 and 142 of the present embodiment are a combination of devices and software/firmware configured to couple computer-based systems to the Internet over a wired line. However, it should be appreciated that in differing embodiments the links 122, 132 and 142 can take the forms of modems, networks interface card, serial buses, parallel busses, WAN or LAN interfaces, wireless or optical interfaces and the like as may be desired or otherwise dictated by design choice.

The exemplary document provider 140 is a server-based device having an interface to the Internet. The exemplary sources 120 and clients 130 are personal computers having an interface to the Internet. However, the particular makeup of these devices 120, 130 and 140 can vary from embodiment to embodiment to include practically any computer-based device capable of storing and/or retrieving electronic documents.

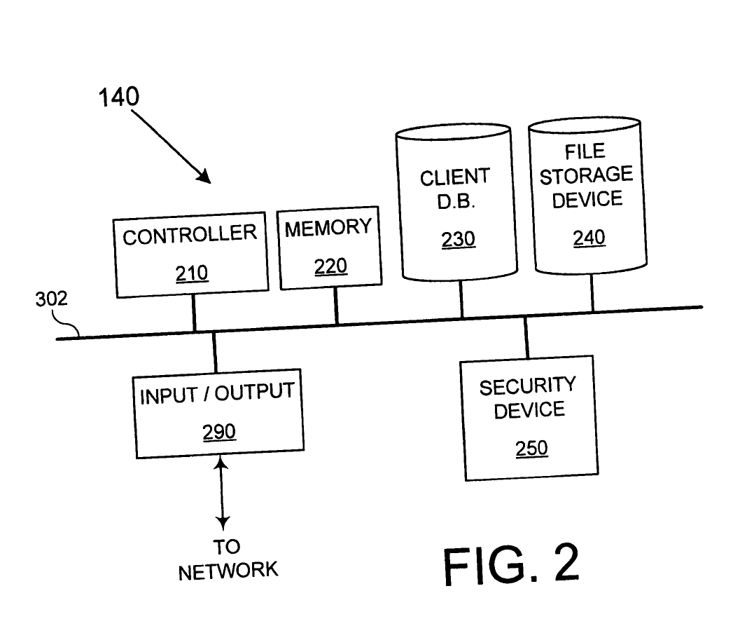

FIG. 2 is an exemplary document provider 140 according to the disclosed methods and systems. As shown in FIG. 2, the document provider 140 includes a controller 210, a memory 220, a client database 230, a file storage device 240, a security device 250 and an input/output device 290. The above components 210-290 are coupled together by control/data bus 202. Although the document provider 140 uses a bussed architecture, it should be appreciated that any other architecture may be used as is well known to those of ordinary skill in the art. Further, it should be appreciated some of the above-listed components can take the form of software/firmware routines residing in memory 220 and executed by the controller 210.

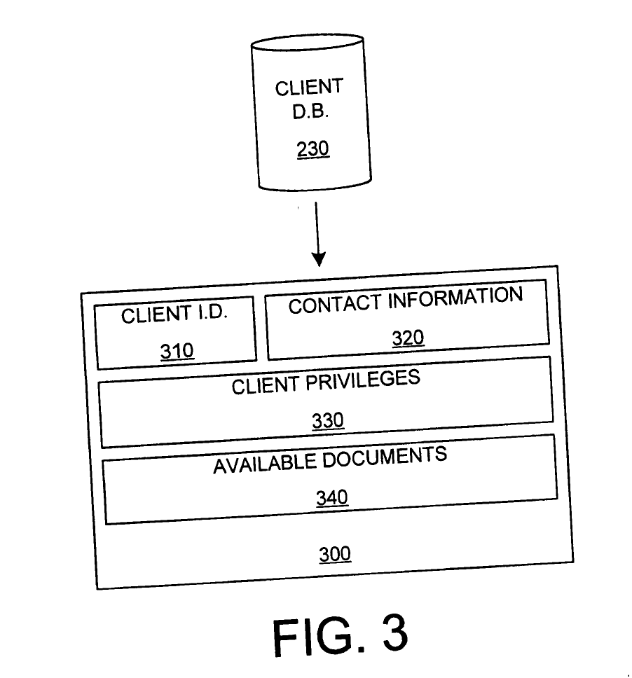

In operation, an operator using the document provider 140 can develop the client database 230. FIG. 3 depicts the client database 230 of FIG. 2 along with an exemplary client record 300. As shown in FIG. 3, the client record contains an identification field 310, a contact information field 320, a field containing a list of client privileges 330 and a field listing any documents available to the client 340.

The client identification field 310 can generally contain any combination of data useful for identifying a client, such as some alphanumeric string unique to a client, a password, an Internet address and so on.

The contact information field 320 can contain a number of contact preferences, e.g., email, voicemail, pager etc, as well as the appropriate email address, voicemail number, pager number etc that a client may preferably use to receive messages from an Internet-based server.

The client privileges field 330 and available documents field 340 can be used to define the services and documents available to the respective client.

Returning to FIG. 2, once the client database 230 is populated with information directed to a particular client, various documents intended for delivery to such client can be stored in the file storage device 240.

Once such documents are stored, the security device 250, which is responsible for all issues of document security for the document provider 140, can deliver a message to the intended recipient via whatever contact means is required or preferred. For example, the security device 250 can send an email to the intended recipient informing him that the document provider 250 has one or more documents ready for electronic delivery. Since this message contains no information from the documents themselves, no information has been compromised.

Once the client has responded by logging into the document provider 140, the security device 250 can access the client database 230 to determine those privileges and documents for which the client is entitled, then restrict access accordingly.

Assuming that the client downloads the appropriate documents, the security device 250 can provide an indication to the documents' source or other third party that the client has received/downloaded the appropriate regulatory-related documents.

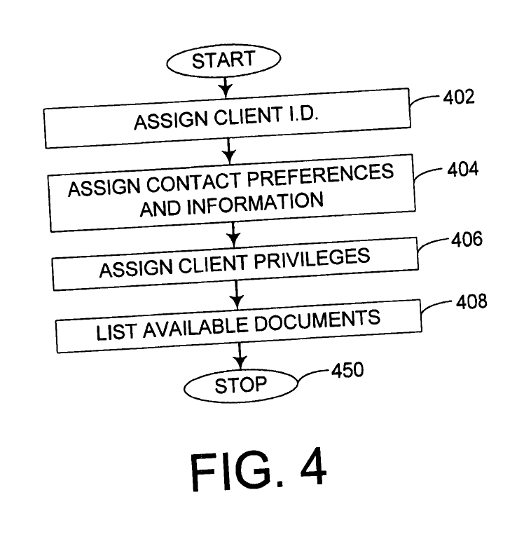

FIG. 4 depicts is a flowchart outlining an exemplary operation according to the present disclosure useful for setting up a client account for a document delivery server. The process starts at step 402 where a government regulatory official or similar entity is assigned a client identification code and password, or any other equivalent or similar information useful to identify an individual or group to a server/website. Next, in step 404, contact preferences and information, such as a list of email addresses, are assigned to the client account. Control continues to step 406.

In step 406, a list of client privileges, such as the ability to view certain pages or any of the other privileges discussed above, are assigned to the client account. Next, in step 408, a number of available documents that should be made available to the client account are listed. Control continues to step 450 where the process stops.

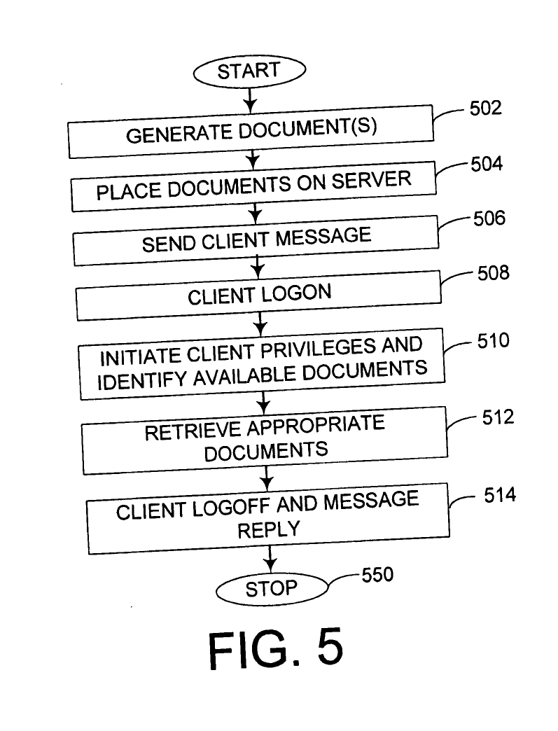

FIG. 5 is a flowchart outlining a second exemplary operation according to the present disclosure for delivering regulatory-related documents to the appropriate officials. The process starts at step 502 where an individual or group of individuals generate a number of official regulatory documents that normally require a hardcopy delivered by post, courier or by hand. Next, in step 504, copies of the generated documents are placed on a server or other networked computer having access to the Internet. Then, in step 506, a message can be sent, either automatically or manually, from the server to the intended recipient of the documents via pager, email, voicemail, instant-messaging, facsimile or other electronic means, informing the recipient client that a number of documents await him/her for download from the server/website. Control continues to step 508.

In step 508, the recipient client (presumable in response to the message of step 506) can log onto the server using appropriate identification information with optional password and Internet address verification. Next, in step 510, the server can initiate/enable the appropriate privileges and identify any available documents, such as the documents of steps 502-504, to the client. Control continues to step 512.

In step 512, once logged on and appropriately enabled the client can retrieve the appropriate documents. Next, in step 514, the client can log off from the server, and an automatic message can be delivered to an appropriate authority, such as the originator(s) of the documents, indicating that the server has been accessed and/or the appropriate documents retrieved. Control then continues to step 550 where the process stops.

In various embodiments where the above-described systems and/or methods are implemented using a programmable device, such as a computer-based system or programmable logic, it should be appreciated that the above-described systems and methods can be implemented using any of various known or later developed programming languages, such as “C”, “C++”, “FORTRAN”, Pascal”, “VHDL” and the like.

Accordingly, various storage media, such as magnetic computer disks, optical disks, electronic memories and the like, can be prepared that can contain information that can direct a device, such as a computer, to implement the above-described systems and/or methods. Once an appropriate device has access to the information and programs contained on the storage media, the storage media can provide the information and programs to the device, thus enabling the device to perform the above-described systems and/or methods.

For example, if a computer disk containing appropriate materials, such as a source file, an object file, an executable file or the like, were provided to a computer, the computer could receive the information, appropriately configure itself and perform the functions of the various systems and methods outlined in the diagrams and flowcharts above to implement the various functions. That is, the computer could receive various portions of information from the disk relating to different elements of the above-described systems and/or methods, implement the individual systems and/or methods and coordinate the functions of the individual systems and/or methods to conduct regulatory document distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for providing regulatory-related documents to a government entity, the apparatus comprising:
a computer-based server, the computer based server including a network interface coupled to the Internet;
a first memory coupled to the computer-based server, the first memory containing number of regulatory-related documents, each regulatory-related document being a deliverable product directed to a regulatory agency of a government;
a second memory coupled to the computer-based server, the second memory containing a client database, the client database including information related to one or more clients; and
a security device coupled to the first and second memory, the security device being configured to restrict access of at least a first regulatory-related document in the first memory to a first client based on information in the second memory.

2. The apparatus of claim 1, wherein the first client is an official of a regulatory agency of a government or a representative of an organization working with the government.

3. The apparatus of claim 2, wherein the first client is an official or representative of a regulatory agency of the United States government.

4. The apparatus of claim 1, wherein the first regulatory-related document is directed to at least one of manufacturing, maintenance, product compliance, testing and certification of a product.

5. The apparatus of claim 4, wherein the first regulatory-related document is directed to at least one of manufacturing, maintenance, product compliance, testing and certification of a civilian aviation-related product.

6. The apparatus of claim 1, wherein the first regulatory-related document is directed to at least one of compliance and certification of a government-sponsored service.

7. The apparatus of claim 4, wherein the client database includes a plurality of records with each record containing at least a client identifier with a related password, and a set of privileges defining access rights for the client associated with the client identifier.

8. The apparatus of claim 2, wherein the security device is configured to send an email to the first client informing the first client that the apparatus has one or more documents intended for the first client.

9. The apparatus of claim 8, wherein the security device is configured to provide access of the first regulatory-related document to the first client based on identification and password information provided by the first client.

10. The apparatus of claim 9, wherein the security device is further configured to provide access of the first regulatory-related document to the first client based on Internet address information of the first client.

11. The apparatus of claim 9, wherein the security device is further configured to provide an indication to a third party that the first client has received the first regulatory-related document.

12. The apparatus of claim 1, wherein the first regulatory document is directed toward at least one of workplace safety, energy, accounting, banking, internal revenue, mineral resources, emergency management and assistance, commercial practices, commerce and foreign trade, elections, commodity and securities exchanges, employees benefits, homeland security, national defense and agriculture.

13. A memory assessable to an apparatus for providing regulatory-related documents to a government entity, the memory comprising a plurality of records with each record including:
a client identification field directed to a first official of a regulatory agency of the United States government;
a client contact information field having an electronic mail address of the first official; and
one or more fields indicating at least one document reserved for the first official, each document being a regulatory-related document being a deliverable product directed to a regulatory agency of a government.

14. The memory of claim 13, wherein the one or more fields indicating at least one document reserved for the first official, each document being a regulatory-related document being a deliverable product directed to a regulatory agency of the United States government.

15. The memory of claim 13, wherein each record further includes one or more fields indicating each indicating privileges reserved for the first official, with at least one privilege being directed to an information page or a service of a website.

16. A method for providing regulatory-related documents to a government entity, the method comprising:
receiving and storing a number of first regulatory-related documents, each regulatory-related document being a deliverable product directed to a first regulatory agency of the United States government, wherein access to the regulatory-related documents is restricted based on first restriction information;
sending a first message to a first official of the first regulatory agency over a non-secure network;
receiving identification information from the first official, the identification information being keyed to provide access to the first regulatory-related documents; and
providing access of the first regulatory-related documents to the first official based on the received identification information and the first restriction information.

17. The method of claim 16, wherein the first regulatory-related document is directed to at least one of manufacturing, maintenance, product compliance, testing and certification of a product.

18. The method of claim 16, wherein the step of sending a first message is performed automatically based on the identification of the intended recipient of the first regulatory-related documents.

19. The method of claim 16, wherein access to the first regulatory-related documents is further based upon at least one of a password and an Internet address of the first official.

20. The method of claim 16, further comprising a step of sending a second message to an individual responsible for the delivery of the first regulatory-related documents based to access being granted of the first regulatory-related documents to the first official.
